(19) United States
(12) Patent Application Publication
(10) Pub. No.: US 2019/0061035 A1
(43) Pub. Date: Feb. 28, 2019

(54) SYSTEM AND METHOD FOR JOINING COMPONENTS

(71) Applicant: PRATT & WHITNEY CANADA CORP., Longueuil (CA)

(72) Inventors: Jean FOURNIER, Longueuil (CA); Alain BOUTHILLIER, Longueuil (CA)

(21) Appl. No.: 15/686,705

(22) Filed: Aug. 25, 2017

(51) Int. Cl. B23K 1/20; B23K 3/08; B23K 11/11

(52) U.S. Cl. CPC B23K 1/20; B23K 11/11; B23K 3/08

(57) ABSTRACT

A system and method for joining components together by projection welding and brazing are disclosed. In one embodiment, the method makes use of one or more weld projections extending from a first component and one or more spacer projections extending from either or both of the components. The one or more weld projections are taller than the one or more spacer projections by a meltdown distance that permits projection welding of the first and second components and permits the one or more spacer projections to define a brazing gap between the first and second components after projection welding.

### TECHNICAL FIELD

The disclosure relates generally to joining components together and more specifically to a system and method useful for joining components using a filler material.

### BACKGROUND OF THE ART

The joining of metal components, such as by using brazing, involves preparation of the bonding surfaces, positioning the components closely together, and applying heat to a joint area and a brazing filler metal compound. The filler metal when molten is drawn into the joint gap between the bonding surfaces by liquid surface tension and capillary action. After filling, metal components and brazing metal is cooled. The preparation of the bonding surfaces may include machining, grinding or applying of flux.

Positioning the components relative to each other may include an assembly jig or fixture so that a gap suitable for brazing is provided. Another approach can be the use tack welds on exposed outer surfaces of the components using spot welding, arc welding, TIG welding with wire consumables or ball-tacking for example. Tack welds used to hold components during brazing can create stress concentrations due to the residual thermal stresses and due to abrupt transitions between the weld and the metal components joined. Removal of tack welds or grinding welds smooth is sometimes necessary to preserve the shape of the surfaces of the metal components and to reduce stress concentrations. It can be difficult to obtain a relatively uniform gap between the components that is suitable for brazing using existing approaches for positioning the components relative to each other in preparation for brazing.

### SUMMARY

In one aspect, the disclosure describes a method of joining two components at bonding surfaces, the components including one or more weld projections extending a weld projection height from at least one of the bonding surfaces and including one or more spacer projections extending a spacer projection height from at least one of the bonding surfaces, the weld projection height being greater than the spacer projection height. The method comprises:

contacting the one or more weld projections of one component with the other component;

projection welding the components together by:

melting a distal portion of each of the one or more weld projections; and

deforming the one or more distal portions of the one or more weld projections against the other component; and

ceasing the projection welding of the components when the one or more spacer projections of one component contact the other component, the one or more spacer projections defining a gap between the bonding surfaces.

The method may comprise, after ceasing the projection welding, brazing the components together using a brazing material at least partially filling the gap defined between the bonding surfaces.

In some embodiments, at least one of the bonding surfaces is planar.

In some embodiments, at least one of the bonding surfaces is curved.

The one or more weld projections may have a conical shape, cylindrical shape or pyramidal shape.

The one or more weld projections may comprise a rib.

The one or more spacer projections may have a semi-spherical shape.

The method may comprise:

conducting electric current from one component to the other component via the one or more weld projections to cause melting of the one or more weld projections; and

urging the two components toward each other when deforming the one or more distal portions of the one or more weld projections.

The method may comprise, after ceasing the projection welding, joining the components together using a filler material at least partially filling the gap defined between the bonding surfaces.

Embodiments may include combinations of the above features.

In one aspect, the disclosure describes a method of joining two components at bonding surfaces, a first component including a weld projection extending a weld projection height from a first bonding surface of the first component, the first component or a second component including a spacer projection extending a spacer projection height from the first bonding surface or from a second bonding surface of the second component, the weld projection height being greater than the spacer projection height. The method may comprise:

contacting the weld projection of the first component with the second component;

projection welding the first and second components together by:

melting a distal portion of the weld projection; and

deforming the distal portion of the weld projection against the second component; and

ceasing the projection welding of the first and second components when the spacer projection of the first or second component contacts the other of the first or second component, the spacer projection defining a gap between the first and second bonding surfaces.

The method may comprise, after ceasing the projection welding, joining the components together using a filler material at least partially filling the gap defined between the first and second bonding surfaces.

The method may comprise passing electric current between the first component and the second component via the weld projection to cause melting of the weld projection.

Embodiments may include combinations of the above features.

In one aspect, the disclosure describes a system for joining of first and second components. The system comprises:

one or more weld projections extending from the first component, the one or more weld projections extending a weld projection height from a bonding surface of the first component; and

one or more spacer projections extending from at least one of the first and second components, the one or more spacer projections extending a spacer projection height from at least one of the bonding surface of the first component and the bonding surface of the second component;

wherein the weld projection height is greater than the spacer projection height and the one or more spacer projections are sized to define a desired brazing gap between the bonding surfaces of the first and second components after welding deforms the weld projections.

In some embodiments, at least one of the bonding surfaces is planar.

In some embodiments, at least one of the bonding surfaces is curved.

The one or more weld projections may have a conical shape, cylindrical shape or pyramidal shape.

The one or more weld projections may comprise a rib.

The one or more spacer projections may have a semi-spherical shape.

Embodiments may include combinations of the above features.

Further details of these and other aspects of the subject matter of this application will be apparent from the detailed description included below and the drawings.

### DESCRIPTION OF THE DRAWINGS

FIG. 1 is an axial sectional view through two exemplary components to be joined together, the upper component including two conical or pyramidal weld projections and six semi-spherical spacer projections.

FIG. 2 is an axial sectional view through the components with the weld projections engaging the bonding surface of the lower metal component.

FIG. 3 is an axial sectional view through the components after projection welding of the two components where the spacer projections abut or engage with the bonding surface of the other component, thereby defining a gap between the bonding surfaces.

FIG. 4 is an axial sectional view through the components after brazing.

FIG. 5 is a detail axial sectional view through the components of the right side of FIG. 1 showing exemplary relative dimensions of a weld projection and spacer projections.

FIGS. 6A and 6B are axial sectional views through other exemplary components to be joined together where the components have curved bonding surfaces.

FIGS. 7A and 7B are detail axial sectional views through other exemplary components to be joined together showing weld projections and spacer projections of different shapes.

### DETAILED DESCRIPTION

The following describes a system and method of joining two components each having a bonding surface using a combination of projection welding and brazing or soldering. In various embodiments, either or both components can have one or more weld projections that are used to tack weld the components together using projection welding. Either or both components can have one or more spacer projections that are used to define a desired gap between the two components after the projection welding so as to facilitate subsequent joining of the two components using a filler material at least partially filling the gap defined between the two components. In some embodiments, the system and method disclosed herein can be used to join parts of gas turbine engines. For example, such parts can include fuel injector pads being joined to a surface of a combustor wall of the gas turbine engine.

Projection welding is a form of resistance welding that does not use consumable filler metals such as wire, rods, flux or other welding consumables. Resistance welding creates localized heat by passing electric current through relatively small contact zones of the (e.g., metallic, electrically conductive) components to be joined together to cause melting at the contact zones via Joule heating. Projection welding is a variation of resistance welding where projections of suitable shape(s) are formed on at least one bonding surface or other part(s) of one or both components. The components are clamped together with the projections contacting the bonding (or other) surface of the other component. Electrical current passing between the components takes the path of least resistance through the projections in contact with the other component. The metal of the heated projection softens (i.e., melts) and the contact surface of the other metal component softens due to the heat caused by electric resistance. The components are urged together such that the softened metals of the projection and the adjacent surface fuse (i.e., weld) the components together when cooled.

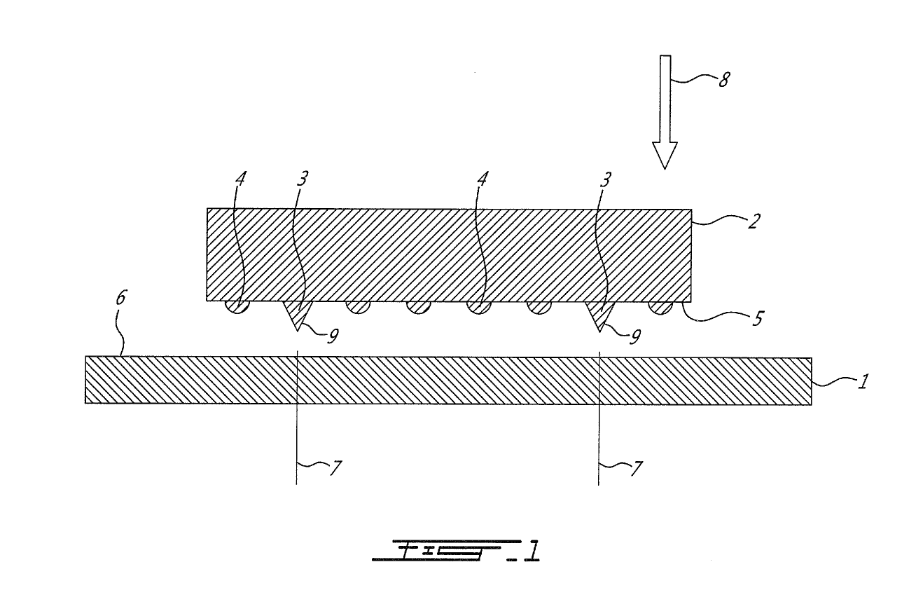

FIG. 1 shows an example where a lower component 1 is a simple flat plate of uniform thickness. The upper component 2 is relatively thicker and could form a boss or mounting pad on a combustor liner of a gas turbine engine for example. The bonding surfaces 5, 6 of the upper and lower components 1, 2 are shown as planar, however bonding surfaces 5, 6 could be curved in one direction or curved in two orthogonal directions (e.g., doubly curved), concave or convex. Two weld projections 3 are shown in sectional view as triangles which suggests a cone shape, a pyramid shape or an elongate (e.g., triangular) rib. The six spacer projections 4 are shown as a semi-circle in sectional view which suggests a semi-spherical or rounded elongated rib. It will be understood that any shape, number and spacing of weld projections 3 and spacer projections 4 can be used depending on the configuration of components 1, 2 and the resulting connection strength required. The weld projections 3 and spacer projections 4 can be shaped as any one or more of: a cone; a pyramid; a semi-sphere; an elongate rib; and a knurled surface. The projections 3, 4 can be formed by casting, cold forming, metal injection molding (MIM), sintering, additive manufacturing, traditional machining, electrical discharge machining (EDM) or any other suitable metal working method.

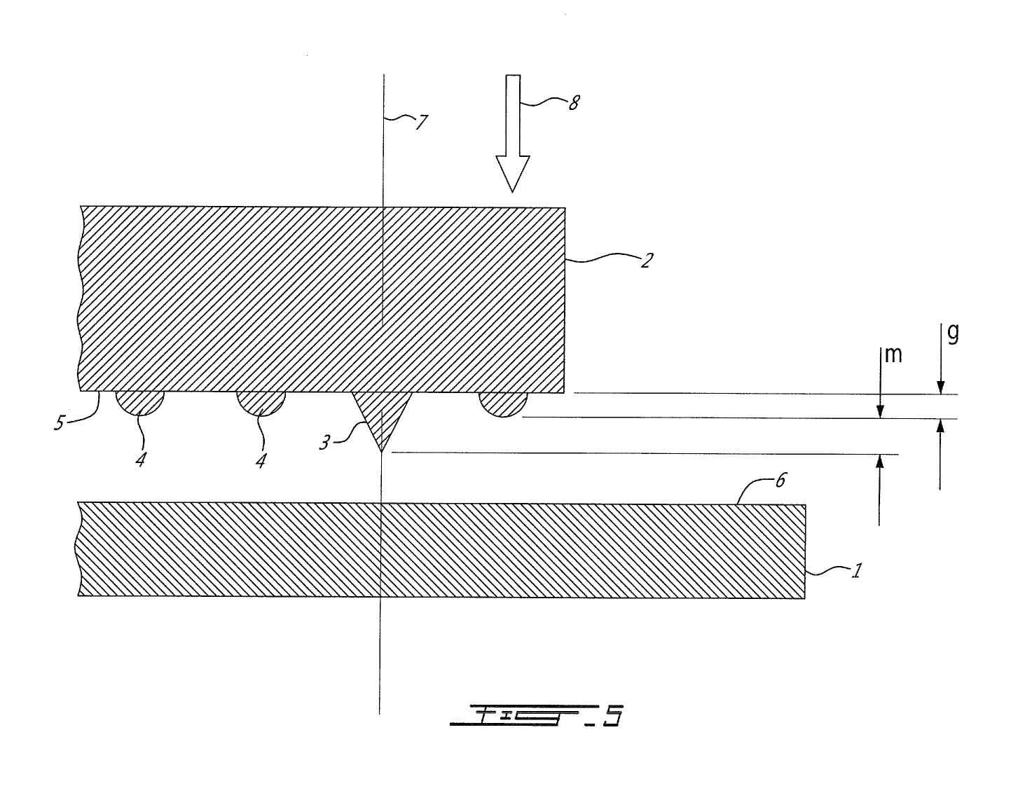

Referring to the detailed view in FIG. 5, the weld projections 3 have a central axis 7 oriented in the direction of travel (arrow 8) through which the upper component 2 is urged towards the lower component 1 during electrical resistance heating and metal welding. The weld projections 3 and spacer projections 4 extend from the bonding surface 5 of the upper component 2 in the example illustrated. No projections are shown extending from the bonding surface 6 of the lower component 1 in the example. However, it is understood that either or both bonding surfaces 5, 6 could have various projections 3, 4 arranged in various patterns.

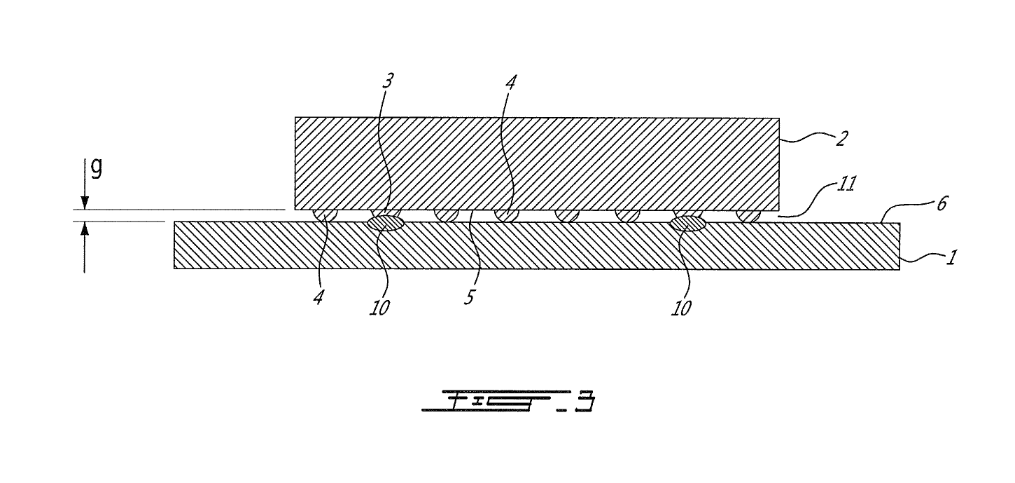

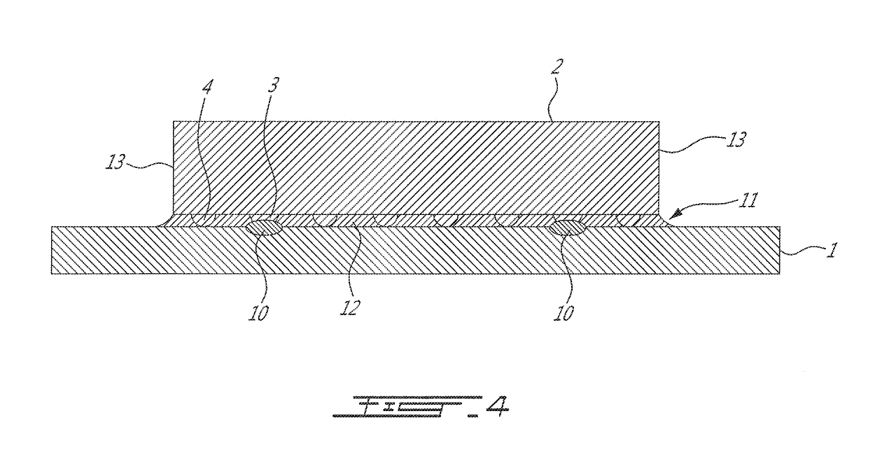

As indicated in FIG. 5, the spacer projections 4 extend a distance “g” (i.e., spacer projection height) being equal to the brazing gap 11 shown in FIGS. 3 and 4. The weld projection 3 extends in the axial direction (arrow 8) from the bonding surface 5 beyond the lower extent of the spacer projections 4 by a meltdown distance “m”. Accordingly, weld projection 3 may have a weld projection height relative to bonding surface 5 that equals the spacer projection height g plus the melt down distance m. In other words, weld projection(s) 3 may be taller than spacer projection(s) 4 by the melt down distance m. In the positions shown in FIGS. 1, 2 and 5, the two components 1, 2 are held in a suitable fixture (not shown).

Those skilled in the art will be familiar with various spot and projection welding machines as well as fixtures that perform the functions of: securing the two components 1, 2 in position relative to each other; passing electric current between the two components 1, 2 or workpieces; urging/moving the two components 1, 2 together as materials are heated and melted; and terminating the passing of the electric current and motion when the resistance welding cycle has been completed. Therefore it is not considered necessary to explain the fixture or welding equipment in detail herein.

In the starting position shown in FIG. 1, the two components 1, 2 are spaced apart and no electrical current passes between them. To commence the projection welding process, the two components 1, 2 are moved together in the direction of travel indicated by arrow 8 parallel to the axis 7 of the weld projection 3. Depending on the welding procedure required for the materials and dimensions involved, electrical current is passed between the two components 1, 2 after physically contacting the weld projection 3 of upper component 2 with the bonding (or other) surface 6 of the lower component 1.

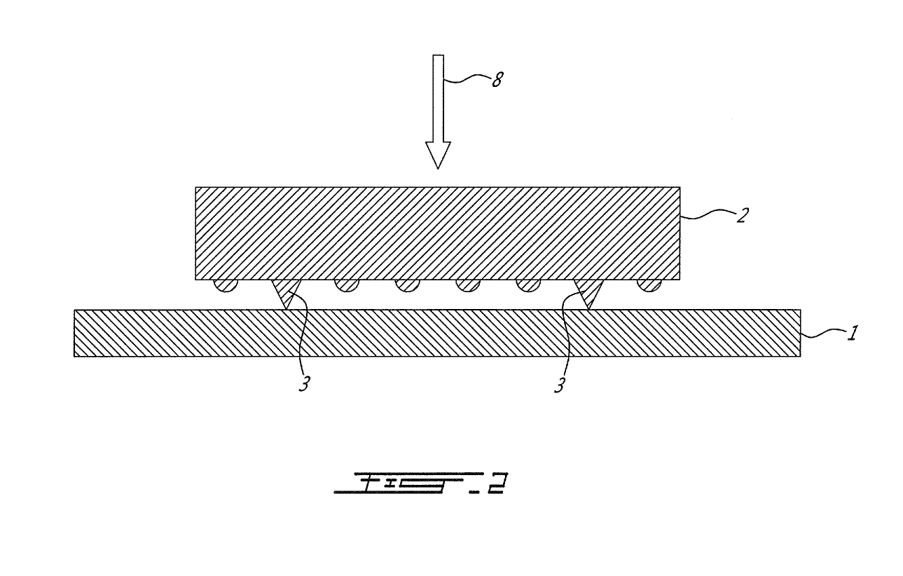

In the position shown in FIG. 2, electric current is conducted to pass from one component 1, 2 to the other through the weld projection 3 to heat and melt the lower distal tip 9 portion (see FIG. 3) of the weld projection 3. At the same time, pressure can be exerted on the components 1, 2 to urge the two components 1, 2 axially in the travel direction (arrow 8) towards each other.

As indicated in FIG. 3, the tip 9 of the weld projection 3 and the local area of the adjacent bonding surface 6 are heated, soften and fuse together to form a weld nugget 10 of metal that serves to tack weld the components 1, 2 together when cooled and solidified. The heated and softened distal tip portion 9 of the weld projection 3 deforms against the heated and softened portion of bonding surface 6 of the lower component 1. The distal tip portion 9 is consumed in the projection welding process, by dimension “m” indicated in FIG. 5 as the meltdown distance “m”, and contributes metal material to the formation of the weld nugget 10. Depending on the metallurgical properties and dimensions involved, it may not be necessary for the welding process to create a pool of molten metal, although this is possible. In some cases, it is sufficient to heat and soften metals which when forced together will bond without liquefying completely.

As indicated in FIG. 3, the projection welding and motion in the direction of travel (arrow 8) is halted when the spacer projections 4 engage with (e.g., contact) the bonding surface 6 of the lower component 1. The spacer projections 4 thereby define a gap 11 of dimension “g” between the bonding surfaces 5, 6. The electric current can be terminated at this point. If electric current is terminated after the projection welding steps are completed, then the components 1, 2 can cool to permit solidification of the weld nugget 10.

As indicated in FIG. 4, to complete the joining method, a brazing or soldering step is commenced during or after the projection welding steps. Brazing involves heating a filler material (e.g., alloy) in contact with the gap 11 to at least partially fill the gap 11 with molten filler alloy 12. The filler alloy 12 or other suitable filler material(s) may serve to form a joint between bonding surfaces 5, 6. The filler alloy 12 may have a lower melting point than that of the material(s) of components 1, 2. The liquid surface tension and contact between molten filler alloy 12 and the gap 11 triggers a capillary action drawing the molten filler alloy 12 into the gap 11. The brazing filler metal alloy 12 is drawn into the gap 11 between bonding surfaces 5, 6, surrounding the remaining proximal portion of the weld projection 3 and surrounding the spacer projections 4.

Alternatively, brazing filler alloy 12 could be in the form of a preformed sheet (not shown) disposed in the gap 11 in the position shown in FIG. 1 before engagement shown in FIG. 2. A preformed sheet of brazing filler alloy 12 could have holes through which weld projections 3 and spacer projections 4 extend. In such an alternative, the step of heating of the brazing filler alloy 12 can occur simultaneously to the conducting of electric current passing between the components 1, 2 during or shortly after the projection welding steps. In other words, projection welding and brazing can occur together or brazing can occur shortly after projection welding before terminating the flow of electric current.

Brazing can be conducted in a batch process in an oven or autoclave under controlled pressure. In such circumstance projection tack welding is completed separately and final brazing occurs later in a separate oven or autoclave. In either case, after brazing is completed the joined components 1, 2 can be cooled to permit solidification of all the heated materials.

As apparent from the finished assembly of components 1, 2 shown in

FIG. 4, the above described process has advantages over external tack welding. In some embodiments, the side surfaces 13 of the upper component 2 can be free of tack welds or other buildup of materials, welding marks or stress concentrating gouges. In some embodiments, the joint between components 1, 2 is not visible except for the thin gap 11 filled with filler alloy 12. If desired, the projection welding procedure can include heating and partial fusing of the distal tips of the spacer projections 4 to add to the bonding strength of the tack welds 10. Partial fusing of the spacer projections 4 would reduce the size of the gap 11 slightly but this can be accommodated for in the manufacturing process, component design and dimensions selected.

The ceasing the projection welding of the components 1, 2 when the spacer projections 4 of one component 1 or 2 contact the other (i.e., opposite) component 1 or 2 can be done in any suitable way. For example, during projection welding, the electric current setting can be determined based on the number and configuration of weld projections 3 to be welded and set accordingly. This setting can be determined experimentally and can be used repeatedly for projection welding components 1, 2 of similar geometries. Power and time for projection welding can be determined experimentally to ensure that the spacer projections 4 will at least get in contact with the other component 1 or 2 during projection welding. As the gap 11 (see FIG. 3) is closing during projection welding and the spacer projections 4 get in contact with the other component 1 or 2, the spacer projections 4 will introduce additional electrically-conductive paths for the electric current, thus dispersing the necessary energy for the projection welding process to continue. The settings or process parameters of projection welding can be selected so that the additional contact points (i.e., conductive paths) provided by the spacer projections 4 will prevent the projection welding process continue beyond this point due to the increased cross-sectional area available for electric current to pass and hence reduction in resistance heating. The passing of electric current for welding can be stopped at a suitable time once spacer projections 4 have made contact with the other component 1, 2 in order to define gap 11 of suitable size g.

Some resistance welding controllers can use power electronics that are able to detect component displacements and also changes in electrical resistance such as the sudden change in electrical resistance associated with the spacer projections 4 coming in contact with the other component 1 or 2. In some embodiments, suitable closed loop control approaches can be used to cease the projection welding process at the appropriate time.

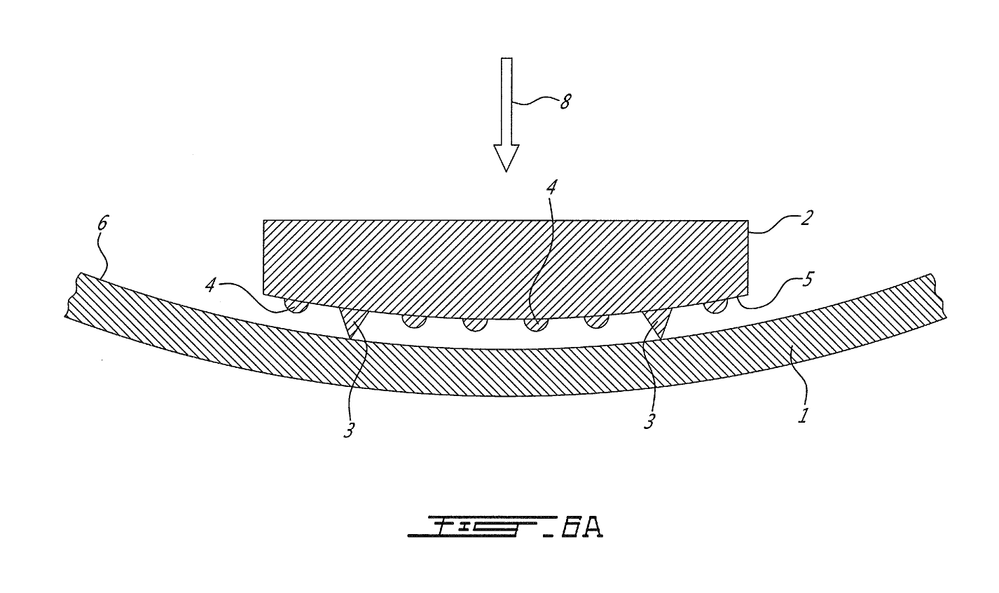

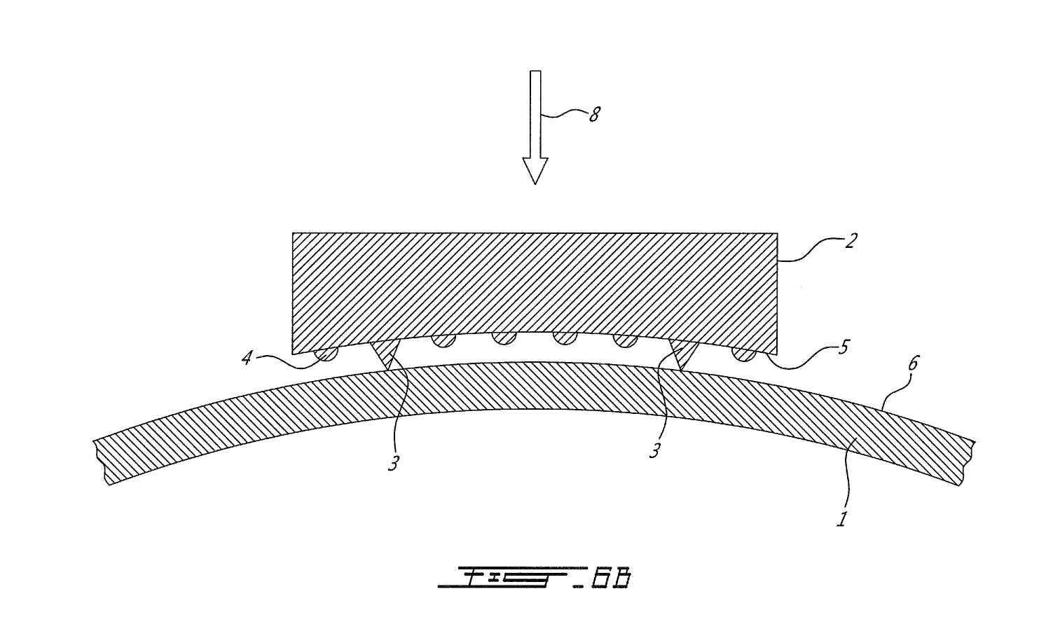

FIGS. 6A and 6B are axial sectional views through exemplary components 1, 2 to be joined together in a state prior to projection welding where the components 1, 2 have curved bonding surfaces 5, 6. FIG. 6A shows bonding surface 5 of component 2 being convex and bonding surface 6 of component 1 being concave. FIG. 6B shows bonding surface 5 of component 2 being concave and bonding surface 6 of component 1 being convex.

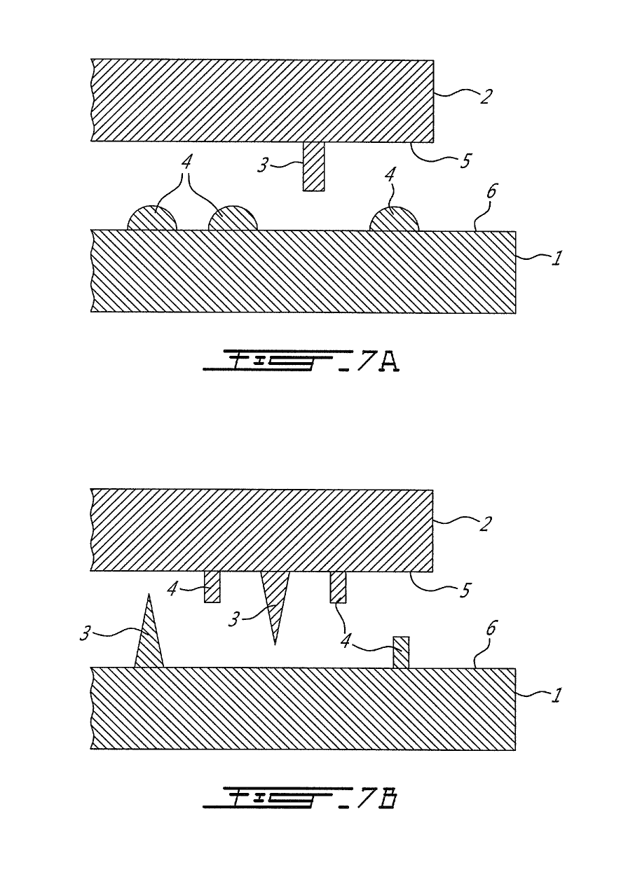

FIGS. 7A and 7B are detail axial sectional views through other exemplary components 1, 2 to be joined together in a state prior to the contact of the weld projections 3 with opposite bonding surfaces 5, 6. FIGS. 7A and 7B show weld projections 3 of different shapes and also spacer projections 4 of different shapes. FIG. 7A shows a weld projection 3 extending from bonding surface 5 of component 2 and a plurality of spacer projections 4 extending from bonding surface 6 of component 1. FIG.

7B shows weld projections 3 extending from both bonding surfaces 5 and 6, and also spacer projections 4 extending from both bonding surfaces 5 and 6. Based on the present disclosure, it will be understood that projections 3 and/or 4 need not necessarily project directly from corresponding bonding surfaces 5, 6. For example, even though the weld projection height and the spacer projection height may be measured relative to bonding surface(s) 5, 6, projections 3 and/or 4 may be connected and extend from other (i.e., non-bonding) surface(s) of components 1 and/or 2 in some embodiments.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims.

What is claimed is:

1. A method of joining two components at bonding surfaces, the components including one or more weld projections extending a weld projection height from at least one of the bonding surfaces and including one or more spacer projections extending a spacer projection height from at least one of the bonding surfaces, the weld projection height being greater than the spacer projection height, the method comprising:
contacting the one or more weld projections of one component with the other component;
projection welding the components together by:
melting a distal portion of each of the one or more weld projections; and
deforming the one or more distal portions of the one or more weld projections against the other component; and
ceasing the projection welding of the components when the one or more spacer projections of one component contact the other component, the one or more spacer projections defining a gap between the bonding surfaces.

2. The method according to claim 1, comprising, after ceasing the projection welding, brazing the components together using a brazing material at least partially filling the gap defined between the bonding surfaces.

3. The method according to claim 1, wherein at least one of the bonding surfaces is planar.

4. The method according to claim 1, wherein at least one of the bonding surfaces is curved.

5. The method according to claim 1, wherein the one or more weld projections have a conical shape.

6. The method according to claim 1, wherein the one or more weld projections have a cylindrical shape.

7. The method according to claim 1, wherein the one or more weld projections comprise a rib.

8. The method according to claim 1, wherein the one or more spacer projections have a semi-spherical shape.

9. The method according to claim 1, comprising:
conducting electric current from one component to the other component via the one or more weld projections to cause melting of the one or more weld projections; and
urging the two components toward each other when deforming the one or more distal portions of the one or more weld projections.

10. The method according to claim 1, comprising, after ceasing the projection welding, joining the components together using a filler material at least partially filling the gap defined between the bonding surfaces.

11. A system for joining of first and second components, the system comprising:
one or more weld projections extending from the first component, the one or more weld projections extending a weld projection height from a bonding surface of the first component; and
one or more spacer projections extending from at least one of the first and second components, the one or more spacer projections extending a spacer projection height from at least one of the bonding surface of the first component and the bonding surface of the second component;
wherein the weld projection height is greater than the spacer projection height and the one or more spacer projections are sized to define a desired brazing gap between the bonding surfaces of the first and second components after welding deforms the weld projections.

12. The system according to claim 11, wherein at least one of the bonding surfaces is planar.

13. The system according to claim 11, wherein at least one of the bonding surfaces is curved.

14. The system according to claim 11, wherein the one or more weld projections have a conical shape.

15. The system according to claim 11, wherein the one or more weld projections have a cylindrical shape.

16. The system according to claim 11, wherein the one or more weld projections comprise a rib.

17. The system according to claim 11, wherein the one or more spacer projections have a semi-spherical shape.

18. A method of joining two components at bonding surfaces, a first component including a weld projection extending a weld projection height from a first bonding surface of the first component, the first component or a second component including a spacer projection extending a spacer projection height from the first bonding surface or from a second bonding surface of the second component, the weld projection height being greater than the spacer projection height, the method comprising:
contacting the weld projection of the first component with the second component;
projection welding the first and second components together by:
melting a distal portion of the weld projection; and
deforming the distal portion of the weld projection against the second component; and
ceasing the projection welding of the first and second components when the spacer projection of the first or second component contacts the other of the first or second component, the spacer projection defining a gap between the first and second bonding surfaces.

19. The method according to claim 18, comprising, after ceasing the projection welding, joining the components together using a filler material at least partially filling the gap defined between the first and second bonding surfaces.

20. The method according to claim 19, comprising passing electric current between the first component and the second component via the weld projection to cause melting of the weld projection.
